(19) United States
(12) Patent Application Publication
(10) Pub. No.: US 2004/0010630 A1
(43) Pub. Date: Jan. 15, 2004

(54) System and method for delivery of information

(76) Inventors: James Becher-Wickes, Esher (GB); Robert David Gwyn Johns, Ruislip (GB)

Correspondence Address: BAKER & HOSTETLER LLP, Suite 1100, Washington Square, 1050 Connecticut Avenue, N.W., WASHINGTON, DC, 20036, US

(21) Appl. No.: 10/305,125

(22) Filed: Nov. 27, 2002

(30) Foreign Application Priority Data
Jul. 15, 2002 (GB) 0216410.1

(51) Int. Cl. G06F 15/16

(52) U.S. Cl. 709/250

(57) ABSTRACT

A system and method for allowing a marketing entity or client to deliver marketing information on a product or service to a target group of consumers. The marketing entity can generate or modify parameters defining at least a part of a consumer interface and these can be associated with consumer data so that a user interface is associated with a target group of consumers. The target group of consumers can then be notified of the existence of the interface. This can be facilitated either by the automatic generation of the notification e.g. by e-mail, fax, or SMS message, or by the generation of contact information for the consumers to allow manual notification e.g. mail, telephone call or fax. The consumers are then able to access the interface and gain access to the information on a product or service. The consumer interface can comprise static information, which is dynamically generated on a request from a consumer and can comprise dynamic information, such as multimedia data.

### FIELD OF THE INVENTION

The present invention relates to a system and method for delivery of information to consumers. More particularly, the present invention relates to methods and apparatuses for allowing marketing entities to deliver marketing information to target groups of consumers.

### BACKGROUND OF THE INVENTION

Advertising is a central part of a marketing campaign for a product or service. However, advertising requires sophisticated means of targeting consumers or resellers because the amount of advertising consumers are exposed to means that something different, and/or something that appears to be targeted to an individual, is required in order to attract the attention of the consumer or reseller and make them aware of the product or service.

Television advertising is not directed at a group of consumers in any way more than a statistical interpretation of the viewers of the program in which the advertisement is placed.

E-mail is a known tool for electronic advertising. E-mails containing video clips or other information can be sent to a specific group of users. However, such e-mails are very large, and may not be accepted by a consumer's e-mail server.

It is possible to send a link to a page of information on the Internet by e-mail. However, such pages are not customised to the individual consumer, and so do not provide a personalised service. Therefore, up-take of consumers requesting more information is low.

Video can be a good way of communicating information regarding products and services either to a reseller of goods and services, or to an end consumer market. The Internet can be a good way of reaching people when using multimedia messaging. However, the application of video on the Internet is currently limited for the purposes of marketing. This is because unless a very good reason exists to watch a video over the Internet, web users do not habitually play back video information that they may encounter on web sites.

This reluctance to make use of video information occurs because Internet users have historically found video technology to be slow to load, complex to use, quirky, and often dependent on video player revisions. In addition, the quality of playback is often poor, and the production values of the producers of the video do not take into account the limitations of data supply speed, or bandwidth, encountered with Internet video transfer. The video provided on web sites is also generally ancillary to the site and is generally stopped from being downloaded by the user to prevent long download times.

### SUMMARY OF THE INVENTION

One aspect of the present invention provides a system and method for allowing a marketing entity to deliver marketing information on a product or service to a target group of consumers. The marketing entity can generate or modify parameters defining at least a part of a consumer interface and these can be associated with consumer data so that a user interface is associated with a target group of consumers. The target group of consumers can then be notified of the existence of the interface. This can be facilitated either by the automatic generation of the notification e.g. by e-mail, fax, or SMS message, or by the generation of contact information for the consumers to allow manual notification e.g. mail, telephone call or fax. The consumers are then able to access the interface and gain access to the information on a product or service.

In one embodiment, a communication network, such as the Internet, can facilitate the method by providing a communication medium to allow the provision of an interface at a server accessible by a consumer. The network can also facilitate notification by automatic electronic notification.

According to another aspect of the present invention, an apparatus and method for facilitating distribution of information over an electronic network is provided. The information distributed is directed to a targeted group of consumers, and is related to a specific product or service, or group of products or services. The interface between the consumer and the information is generated on request by a central interface provider and supplied by the interface provider. The data defining at least part of the interface may be stored on the interface provider. Contact details may also be stored on the interface provider. However, another party may provide some or all of the information. The consumers are targeted directly, and so the information provided is tailored to a specific group, or individual.

The marketing entities may generate or modify parameters stored on the central interface provider. This may be done from any location connected to the interface provider by a communication line. The marketing entities can also modify or generate mailing lists of consumers to be made aware of the existence of the marketing information.

It is possible, and may be highly desirable, that a consumer receiving the information from the distributor forwards the information on to others who may also be interested in the information. Such viral marketing is useful in reaching a larger number of consumers with the same information.

Also, according to another aspect of the present invention, the targeted group of consumers may be given access to information, held or generated centrally, which is accessible by electronic means. They may be given access to the information by receipt of an e-mail, containing an identifier, which may be unique, and which also provides a link to an interface to the information. The information relating to the group of consumers may be stored on the interface provider, or may be held by a third party. The interface provider may also contact the consumers, or this may also be done by a third party, and may be done automatically, or manually. The marketing entities can also modify or generate mailing lists of consumers to be made aware of the existence of the marketing information.

The interface may be configured by a distributor, or may be configured remotely by a marketing entity or client for whom the advertising information is distributed. The client has control over the information provided to each consumer individually, and this can be done conveniently using a computer. The interface is configured by use of parameters, which can be defined by the marketing entity.

In one embodiment, the interface comprises two separate parts, and the two parts may be configurable independently, in order to provide a more individual and relevant experience to the targeted consumer. The two parts are configurable by providing one or more parameters defining parts of the interface. The parameters may relate to any aspect of the consumer interface determined by the administrator of the interface provider, and may be configured remotely by the marketing entity or client.

The interface may be a web page or other consumer interface with hyperlinks and the two parts of the interface may be a static part, holding information and links to other information providers relating to the product or service, and the other part may be dynamic such as a multimedia clip. The dynamic part may be held in a different physical location to the static part and may comprise audio and/or video. The static part of the web page may be generated on demand by the interface provider when requested by a consumer.

In a further embodiment, the two parts each provide a separate aspect of the total information content supplied to the consumer. In this case, the information within the consumer interface comprises a first part, which is information streamed to the consumer, providing the initial focus of the interface, and a second associated static part, which provides useful information and links to other related interfaces, once the streamed information has attracted the attention of the consumer.

Where the dynamic information is streamed to the consumer, that is, the start of the dynamic information begins to be outputted to the consumer before the end of the dynamic information has been received, the delay associated with dynamic download is reduced, and the data retrieval is not as noticeable to the consumer. This is also achieved without all of the dynamic information being sent to the consumer at the distribution stage, before the consumer has requested information.

The static part of the interface may be provided with means to forward the interface to a further consumer. This may be a form, filled in by the consumer, giving the consumer details and further consumer details, which is then submitted to and processed by the interface provider. Details of the further consumer may then be held by the distributor.

In a further embodiment, the marketing entity can generate or modify the consumer interface via the interface provider. The consumer, once notified of information to be viewed by the interface provider on behalf of the marketing entity, can contact the interface provider and request the information. This request can be through the Internet, but can also be through any other suitable communications medium, such as SMS messages, telephone etc.

According to a further embodiment, the interface provider outputs consumer interface parameters to the consumer, which are used to display the consumer interface at the consumer's computer. These interface parameters are outputted over the Internet, but, alternatively, any suitable communications medium may be used. The interface parameters may include information relating to dynamic, streaming data and associated static data. The streaming data may be associated with the static data by the marketing entity, and the association data held by the interface provider in a database.

The streaming data may be video or sound data, or any data representing information to be sensed by any of the senses of a consumer, for example smell or touch, as well as sight and sound. Once again, the static data of the consumer interface may be generated on request from the consumer for the consumer interface.

In one embodiment, the software and hardware available to the consumer, and the speed of connection between consumer and interface provider, are detected automatically before the multimedia clip is sent to the consumer. However, alternatively, only the software, or only the operating system or only the hardware, or any combination of the three could be detected. The dynamic information sent to the consumer may be dependent on the detected speed of connection and usable player(s) for receiving the streamed data. In this way, in almost all cases, no consumer intervention is required in order to initiate correct playback of the dynamic information within the consumer interface.

The multimedia clip may be provided by the client, or may be produced by the distributor. Several static parts of the interface may be associated with a single dynamic information unit, with different static parts being provided to different consumers for the same unit. A single static part may also be associated with a plurality of units.

In the above embodiments, the interface may be dynamically generated when requested by a consumer. This allows the configuration of the interface to be changed by a client even after the consumer has been notified about the interface, and the information provided is kept up to date and relevant so that the consumer can be encouraged to request the interface several times because each time the interface has been changed. If the distributed information comprises a unique reference, when it is returned to the interface provider, the interface can be generated and supplied to the consumer, tailored to that particular consumer.

All of the aspects of the invention may easily be monitored and associated counters kept of the statistical data relating to the consumer use and habits etc. This statistical data may be used to alter the lists of consumers held for a particular type of product or service, and this may be done automatically or manually.

According to another embodiment, the interface may also be used for delivery of proprietary information as well as advertising information, and the delivery of the interface, which could be a music track or album, or film or film clip, could be subject to payment, for example, on a pay-per-view basis or a membership basis.

The embodiments and aspects of the invention described above are not only to be interpreted individually nor solely in combination, but may be combined in any way in order to provide further embodiments of the invention. Additionally, individual features from an embodiment may be combined with other features from another embodiment so that various combinations of individual features from different embodiments and aspects also provide further embodiments of the invention.

### BRIEF DESCRIPTION OF EMBODIMENTS

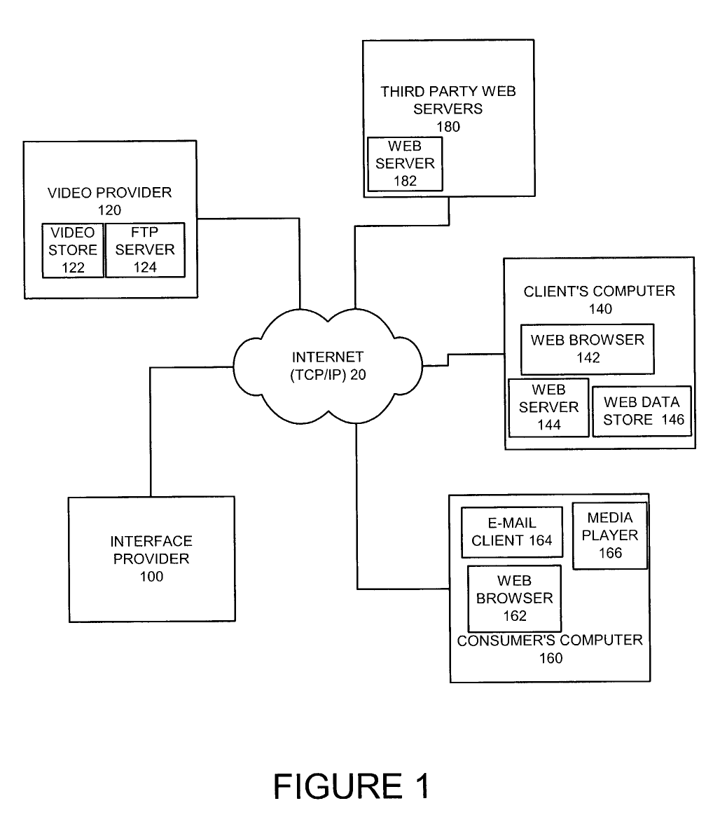

FIG. 1 shows a block diagram of a system according to an embodiment of the present invention;

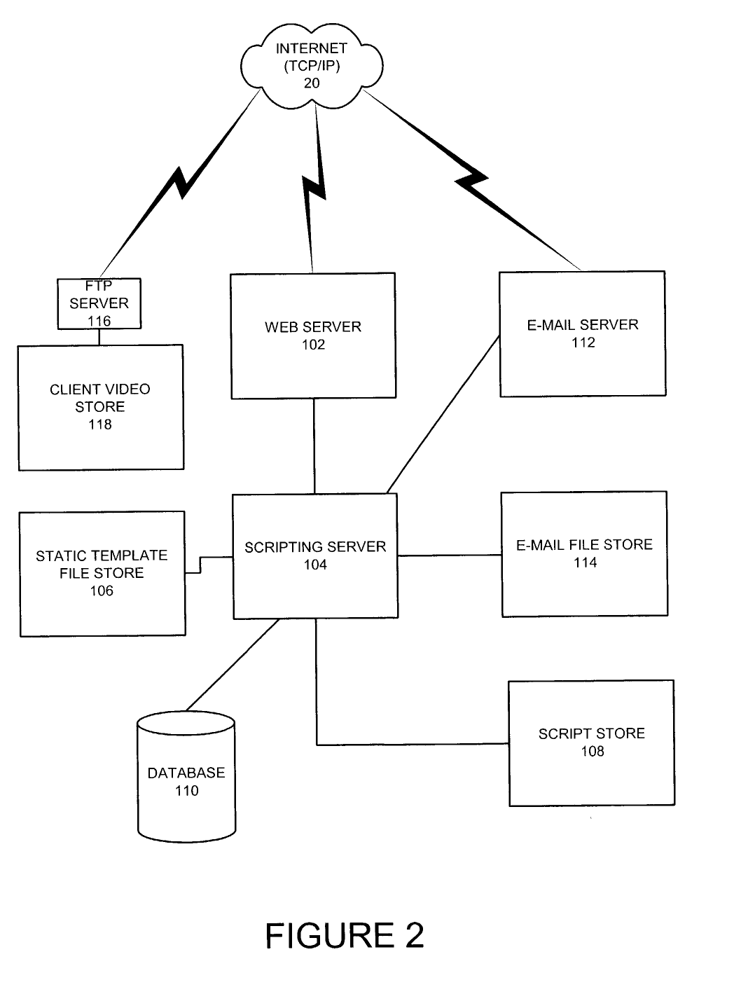

FIG. 2 shows a block diagram of the interface provider shown in FIG. 1;

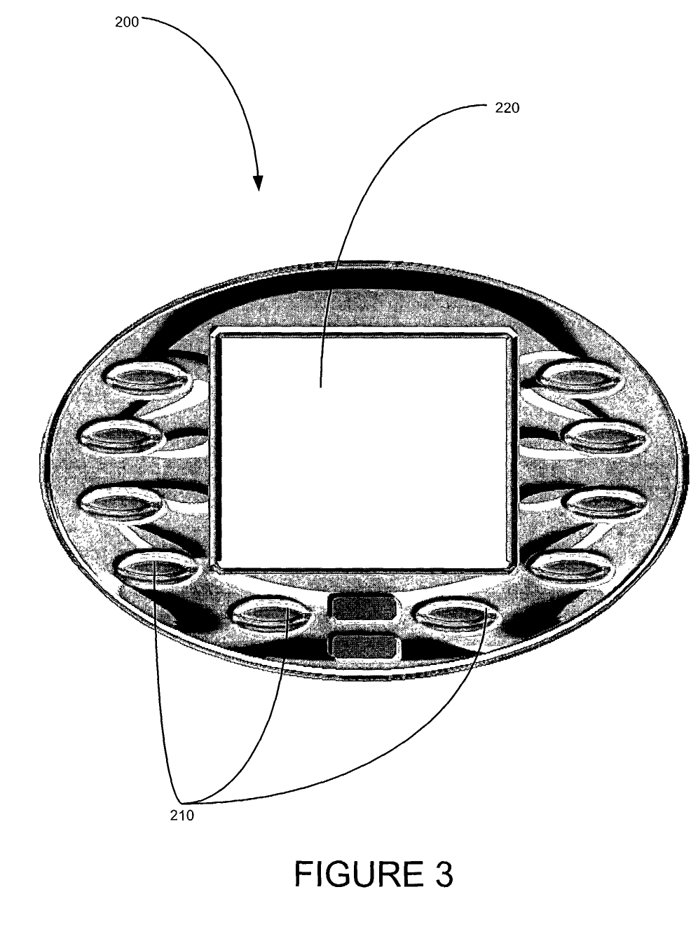

FIG. 3 shows a consumer interface according to an embodiment of the present invention;

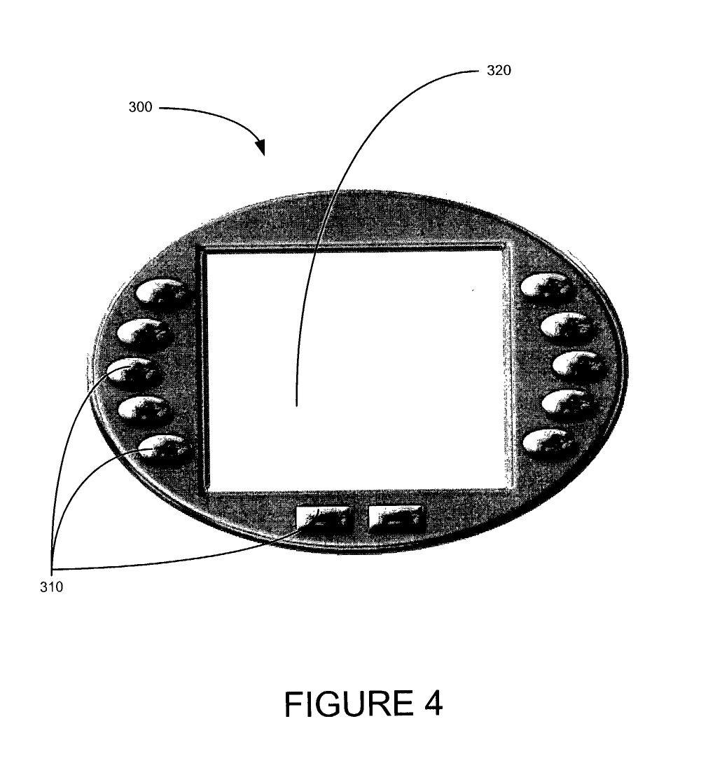

FIG. 4 shows a consumer interface according to an embodiment of the present invention;

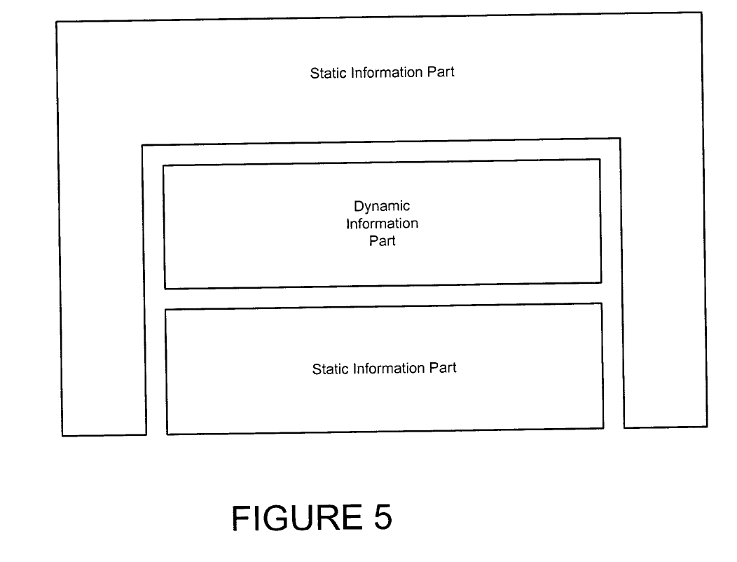

FIG. 5 shows a schematic view of a consumer interface according to an embodiment of the present invention;

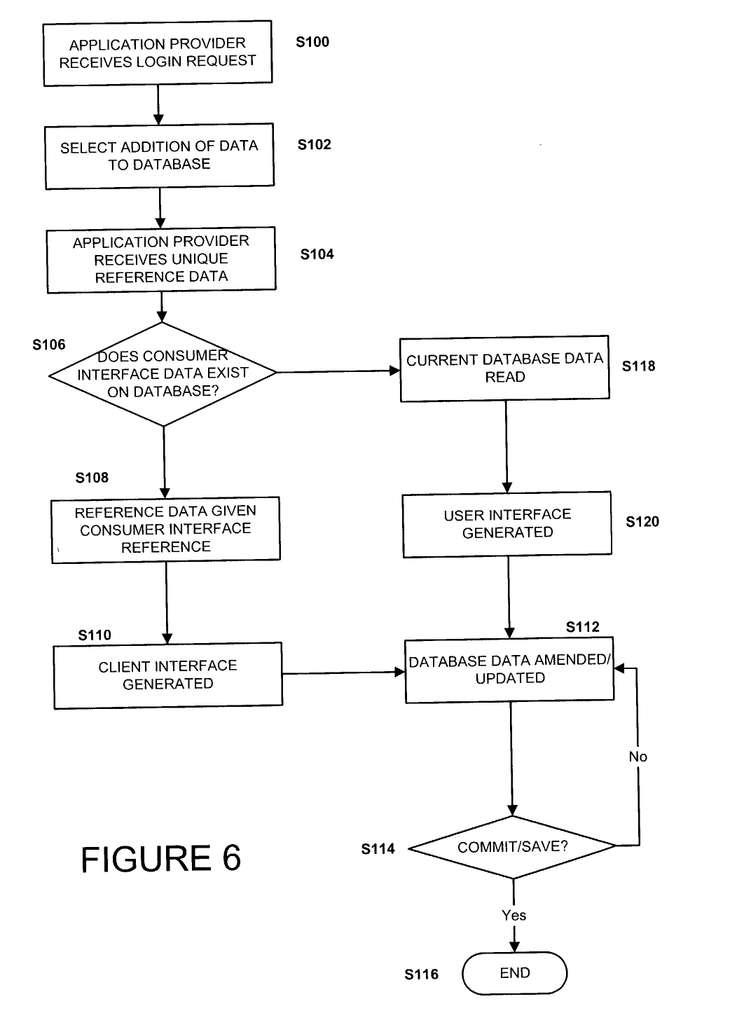

FIG. 6 shows a flow diagram showing one aspect of a method of an embodiment of the present invention;

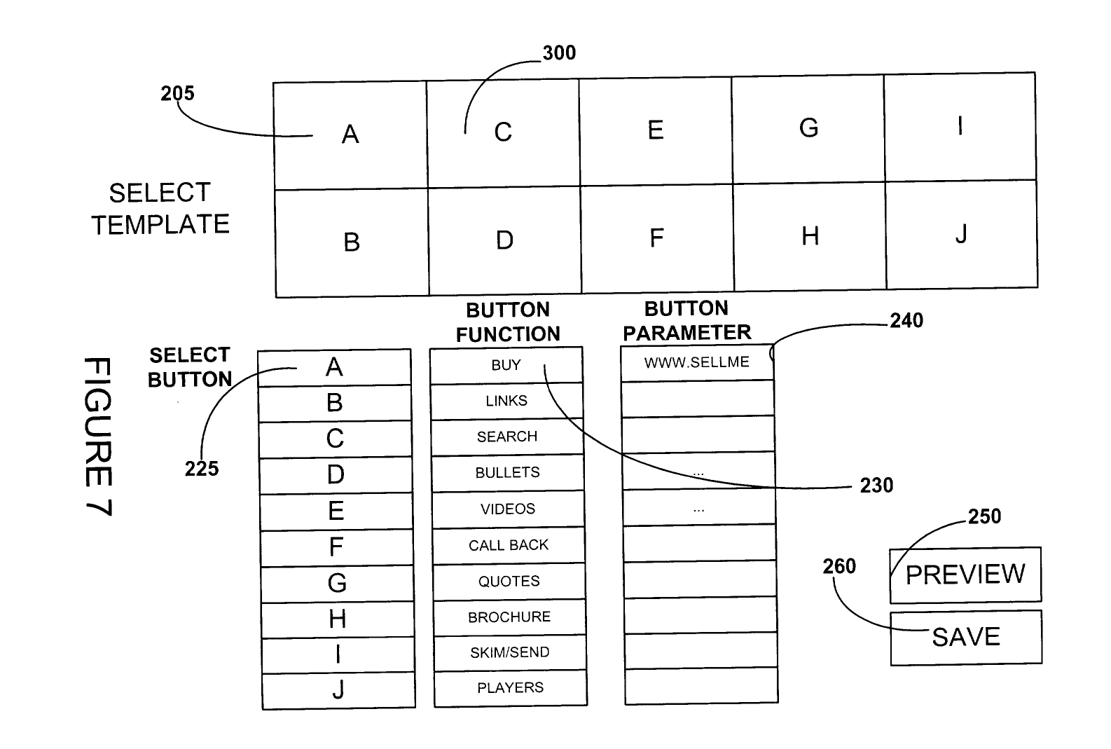

FIG. 7 shows an input interface for use in the method of the embodiment of FIG. 6;

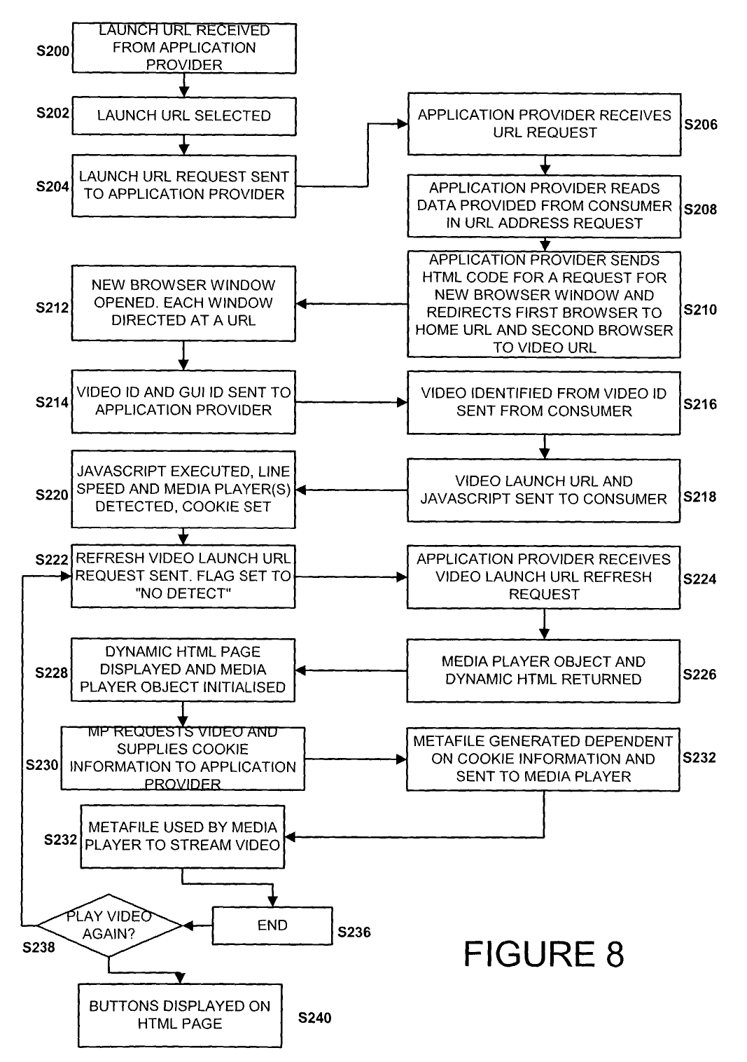

FIG. 8 shows a flow diagram showing a second aspect of a method of an embodiment of the present invention;

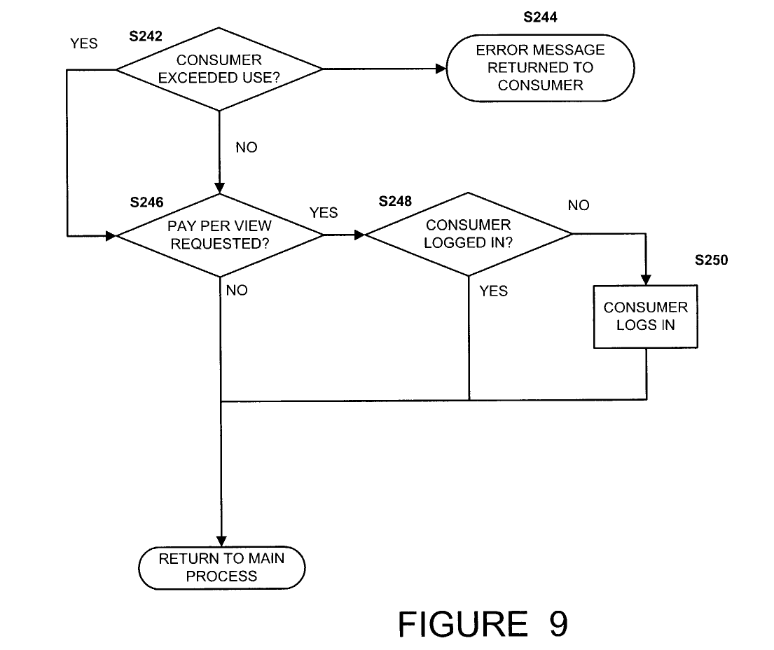

FIG. 9 shows a further flow diagram of the second aspect of the method of the present invention; and

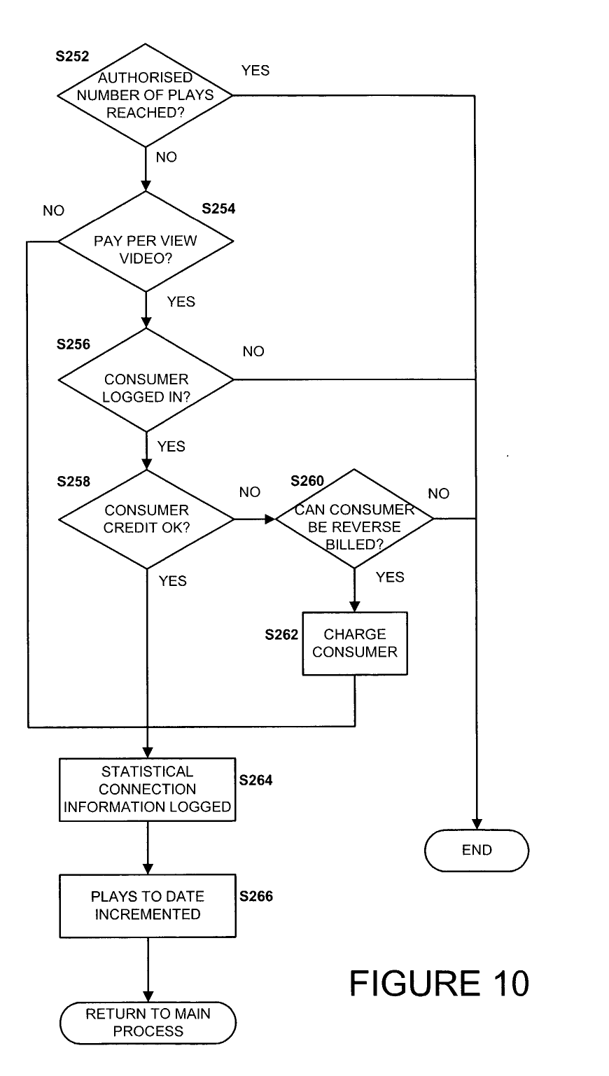

FIG. 10 shows a further flow diagram of the second aspect of the method of the present invention.

### SPECIFIC DESCRIPTION OF EMBODIMENTS

FIG. 1 shows a system of a first embodiment of the present invention. The system comprises an interface provider 100, a video provider 120, one or more client computers 140, one or more consumer computers 160 and one or more third party servers 180 interconnected over the Internet 20 or other communications network e.g. a TCP/IP network, or wireless network.

The video provider 120 comprises a video store 122, a File Transfer Protocol (FTP) server 124 and a streaming server 126. The FTP server 124 is configured to receive video data over the Internet 20 and store it on the video store 122 with a unique reference to allow retrieval. The streaming server 126 is configured to receive requests to supply video data, the requests comprising the unique reference associated with the video data. The streaming server 126 then streams the requested video clip to a media player 166 in the consumer's computer 160. The video provider 120 could be integrated into the interface provider 100.

The client's computer 140 comprises a web server 144, configured to supply web pages to consumers over the Internet 20. The client's computer 140 also comprises a web browser 142 for receiving web pages over the Internet 20.

The consumer's computer 160 has a web browser 162 for receiving web pages over the Internet 20. The consumer's computer 160 also comprises an electronic-mail facility 164 for receiving and reading e-mail, and media player 166 for receiving streamed video and audio data for display.

Of course, the word “computer” is used in the inclusive and general sense rather than the specific sense and the invention may be implemented on any computing device, for example a mobile telephone, a personal computer, a PDA or other hand-held device etc. The important feature of the consumer's computer is that there must be a means of receiving or, at least inputting a reference from the interface provider 100 to the targeted consumer and appropriate means for receiving and displaying the consumer interface.

Third party servers 180 are provided. These have web servers 182 that provide web pages to the web browsers 162 of the consumers 160. However, third party information could be stored on the interface provider 100, in which case, third party servers 180 would not be essential for this purpose.

FIG. 2 shows the components of the interface provider 100. The interface provider 100 comprises a web server 102 connected to the Internet 20. The web server 102 is connected to a scripting server 104. The scripting server 104 dynamically generates static web pages on request and supplies them to the web server 102, to be supplied to consumers. The scripting server 104 dynamically generates the web pages from data stored on a static template file store 106, a script store 108 and a database 110.

The scripting server 104 is also connected to an e-mail server 112, which sends out emails to a targeted group of consumers. The e-mail addresses for the consumers are stored in the database 110, and the format of the e-mails is stored in an e-mail file store 114. The e-mail server 112 and e-mail store 114 are linked via the scripting server 104. Alternatively, the e-mail server 112 and e-mail store 114 may be directly linked. The email server 112 and e-mail store 114 may also be remote to the interface provider 100.

The interface provider 100 also comprises an FTP client 116, which is connected to the Internet 20. The FTP client 116 stores video data from clients on a client video store 118. The FTP client 116 also uploads the video data and unique association references to the video provider 120. Alternatively, the FTP client 116 and client video store 118 may be remote to the interface provider 100.

A client wishing to have a target group of consumers informed of a product or service contacts the owner or administrator of the interface provider 100 and indicates this intention. The client either supplies video data representing a video clip relating to the product or service to be advertised, or instructs the owner or administrator of the interface provider 100 to create a video clip to be held on the client video store 118.

The first time a video clip is made available, the client's computer 140 connects to the web server 102 of the interface provider 100 to generate a consumer interface for the information related to the product or service (as described below). Subsequently, the client's computer 140 can connect to the web server 102 in order to change the appearance of the consumer interface (as described below).

The consumer interface comprises a static information part and a dynamic information part. The static information part is a Mark-up Language web page or the like, suitable to be shown on a web browser of a consumer's computer 160. Examples of such static information parts of the consumer interface are shown in FIGS. 3 and 4.

The static information part 200, 300 of the consumer interface may be changed, and is definable by the client, to provide a different look and feel to the consumer interface. The shape of the static information part and the pattern applied to the static information part may be changed. The static information part also comprises a plurality of buttons 210, 310. The buttons 210, 310 provide links to other web pages or services. The locations and the appearance of the buttons are also definable by the client (as described below).

The static information part 200, 300 also comprises a blank area 220, 320. The blank area 220, 320 provides an area of the consumer interface in which the dynamic information is displayed. The HTML instructions also include an instruction to embed a video player in the blank area 220, 320. Further buttons 312, 314 are shown in FIG. 4. These buttons 312, 314 can be set to provide ‘play’ and ‘stop’ commands for the video player embedded in the static part of the consumer interface.

This dynamic information is a streamed video clip. The dynamic information may additionally comprise streamed audio data, which may relate to the streamed video clip, or be only audio data. The video clip is streamed to the embedded video player and shown in the consumer interface on the consumer's computer screen. FIG. 5 shows a schematic diagram of the consumer interface. The static part is made up of a top and a bottom part. In between these two parts, a video player is embedded.

The client's computer 140 first establishes a connection with the interface provider 100 over the Internet 20 or a point-to-point connection, or the like, and logs on to the interface provider 100, which is password protected.

The client is able to manage the e-mail list held on the database 110. This involves addition, deletion and modification of the addresses held, together with group management, to modify members of groups who are to be targeted with particular information.

The client is able to monitor various statistics such as the number of responses from various e-mail shots sent to targeted groups of consumers. This is possible in real time, rather than hourly or daily updates because the information is available straight from the database 110 in the interface provider 100 and can be read directly.

The client can view all their video clips held on the video provider 120. If suitable permissions are given by the administrator of the interface provider 100, the videos of other clients may also be viewed. The client may be enabled to edit a video clip, either by sending a request to the administrator of the interface provider 100, or by editing the video itself, for example, amending a logo shown at the start or end of the video.

The client can also create or customise the static information part of the consumer interface associated with a video clip. This process is shown in FIG. 6.

Once the client has logged on to the interface provider at S100, they can choose whether to perform “email management”, in which e-mail lists of consumers are updated or modified, “interface management”, in which the consumer interface is generated or modified, or “‘campaign’ management”, in which specific interfaces are associated with specific mailing groups. Within each of these sections the client than has further options for which part of that process they wish to undertake.

The “interface management” option is chosen at S102.

The client has a choice at S104 of whether to create, modify or delete a consumer interface, or manage or send to an e-mail list. It is also possible to generate reports based on a particular campaign, consumer interface, or consumer.

If create is chosen, the client is prompted to enter details of the new consumer interface, including title, description and search key words (to be used as described below) at S106. These details are saved on the database 110. A video is then chosen from those available to the client at S108, and the video ID is stored on the database. A client interface is then generated at S110, in which parameters associated with the consumer interface have no default values. The client can then select the parameters at S112 and save the changes to these parameters to the database at S114 to end the editing session at S116.

If the client chooses to modify an existing consumer interface at S104, the consumer is requested to identify the consumer interface to be modified at S117. The current database values for the parameters are read at S118 and a client interface generated at S120 in which the existing parameters are displayed and it is possible to change them at S112. The editing session may then be ended in the same way by saving the changes to the database at S114 to end the editing session at S116.

The parameters that may be changed are the number of buttons, their function and their appearance and the shape of, and the pattern applied to, the static information part of the consumer interface, and the video associated with the static part of the consumer interface. These are chosen from a pre-set palette as discussed above. Logos and other corporate messages may also be added to the consumer interface.

The static templates from which the client can choose a consumer interface are stored on the static template file store 106. A unique reference to each template is stored in the database. The consumer interface data on the database 110 comprises references to these templates held on the static template file store 106.

The client interface for editing the static information part parameters gives the client several options. The first of these options (although other orders for these options are possible) is to choose the shape and pattern of the static part of the consumer interface. The client is provided with a hierarchical list of categories, which are divided into themes, from which a selection may be made. The list shows small pictures of the static part (“thumbnails”), each of which has a different shape and pattern applied to it.

Each such static part has a number of spaces for buttons. When creating a new consumer interface, each button space is shown with a cross to indicate that a function and button have not yet been associated with that button. The number of spaces for buttons differs between different static parts. Therefore, if amending an existing customer interface, and a static part is chosen with fewer buttons than the existing customer interface, a warning is shown stating that some of the buttons will be lost if the new static part is chosen.

The client selects a static information part template. Examples of these are shown in FIGS. 3 and 4. The buttons of the templates are in a prearranged configuration.

Once a template 200 has been selected, it is shown full size on the client's computer 140 and the client can select any of the buttons to be defined. The client is then shown a screen to select a function for the selected button. FIG. 7 shows an example of a screen from a client interface. The screen shows the buttons that can be chosen for a particular static information part template 200.

The function of the selected button can be changed by way of a drop down menu 250. Some of the button functions have parameters to be entered. The parameters can be inputted into a parameter box on a further screen, which is displayed to the client if the button function is selected for one of the buttons. In this way, each of the buttons arranged around the static information template can be defined to have any of the functions available.

The wording applied to the buttons of the static parts, together with the function of each button can also be assessed. The wording to be placed on the selected button is chosen by selecting the button with the required wording on it. The function and button wording are then saved, and the client is returned to the screen showing the consumer interface for the next button to be defined in the same way as above.

Once all the buttons have been defined by the client, these functions can be displayed to the consumer when the consumer requests the consumer interface. The various core functions of the buttons available are:

“home”: this function provides a single straight link to a website chosen by the client. The client can choose the name of the button, and its function. For example, the button could link to an e-commerce system and use a button marked “buy” or it could link to an information document and use a button marked “info” etc. If no web site has been chosen, the consumer is directed to the “call back” option below;

“links”: the video player of the consumer interface is replaced with a series of links to other related web pages and, if chosen, each link opens a new browser window;

“search”: a new browser window is opened and a search engine is contacted and provided with keywords stored in the database 110 of the interface provider relating to the consumer interface, products or service. The consumer then receives a full search result of the web pages related to the product or service automatically;

“bullets”: text regarding the products or service is shown in place of the video player, this can be provided as a series of slides by including a reference to a slide number for the particular bullet in the relevant database 110 table;

“videos”: the video player is replaced with references to other related videos, the references being held in the database 110 and related to the consumer interface. If a reference is chosen, the interface requests the new video and it is played through the media player in the same interface. Alternatively, the browser could open a new window to play the video. In the alternative case, the new window would not have a full consumer interface, but just the video player, to avoid confusion and overwhelming the consumer with information;

“call back”: the video player is replaced with a form to be filled in by the consumer with personal details and times when an operator should call the consumer by telephone, which are sent to a call-back operator by e-mail;

“custom function”: This is a general purpose button, whereby the owner or administrator of the interface provider 100 can create a bespoke min-application for the client, which will be activated when this button is pressed. For example, this might run a program on the interface provider 100 to provide a quote for the product or service of the consumer interface. Such a program could be formed in two parts, the first part enabling the consumer to indicate the number/amount of product/service to be purchased, and the second to provide a quote based on this amount. The program would be different for different consumer interfaces because quotation formulae would be different for different products or services. Such functions are stored on the script store 108 to be run on the scripting server 104. If no custom function is made available, the consumer is directed to the “call back” function above;

“skim/send”: this allows referral of the consumer interface to a further consumer. The e-mail address of the further consumer is entered, together with the name and e-mail of the consumer making the referral. An e-mail containing the link to the consumer interface is forwarded to the further consumer addressed as though from the referrer. Statistics and data on the referred consumer can be recorded on the database;

“players”: this provides references to downloads of suitable media players in place of the video player or in a new window; and

“help” which is a link to a further page on the interface provider 100 providing guidance and answers to frequently asked questions.

“play” and “stop” buttons are also provided to control the video player embedded in the browser.

Further button functions can be created on request from the client, or where a need is recognised, for example by the administrator of the interface provider 100.

The database 110 has a number of tables associating consumer, client, video and interface parameters. Client parameter tables each store the name, address, and e-mail of a client. Each client table also includes a unique client ID and user name for log-on to the client interface.

Consumer interface tables are also provided. The consumer interface tables each contain fields for a consumer interface unique ID, a client ID associating the consumer interface with the client for the products or service of the consumer interface, a video ID for associating the video clip with the consumer interface, a graphical user interface ID, which comprises fields for an ID for the particular static information part selected, the font size and colour of the static information part chosen and a field for the colour of the links. The graphical user interface ID gives a location on the static template file store for the particular static information part template. Each static information part template has a predetermined size, shape and pattern applied to the buttons and a field is provided to hold a unique ID for each static part. Alternatively, if the static parts do not determine the button properties, then parameters for these may be stored in the database as well. The button information and consumer interface information is spread across several database tables for increased data-storage and decreased retrieval time, in line with normal database procedure.

There are also fields for defining the function of each of the buttons and these fields, in turn refer to the fields containing information regarding each of the functions described above. For example, the references to other web addresses are stored, as is a “custom script file” for executing the client determined custom function. Such a custom script file would be stored on the script store 108. Keywords are also stored, to be exported to a search engine if a search function is requested by a user.

Consumer details are also stored in the database 110. The consumer details stored on the database 110 are the number of credits left (for pay-per-view viewing, as described below); a consumer ID and an associated password for logging in for pay-per-view access; an indication of the initial credits when the consumer was created on the database 110, The last time the consumer played the video is recorded. These details are stored for pay-per-view videos.

A separate table of names and email addresses used in mailing the interfaces out and in tracking the ‘hits’ to the various interface functions, is also provided.

An e-mail address for the consumer is also stored. A further transaction table may be provided which also contains the consumer ID and contains a log and records of all activities for the consumer.

Checking statistics are also recorded on the database. These statistics record the video ID, the portal (interface provider) through which the ID was accessed (if there is more than one interface provider 100), the number of times the particular consumer interface has been requested, both in total for the current time period, the player types used in each case and the connection speeds used when requesting the consumer interface.

Video tables are also provided. Each video table contains a unique video ID for the video clip, a title, a file name and the location of the video, pay-per-view information, whether free to air or the type of pay-per-view used and the cost, a client ID, where each video clip for the same client will have the same client ID. The number of plays to date is stored, together with the total number purchased by the client. The video format and dimensions are also stored, together with the duration of the video and certification of video, for example PG, 15, 18 etc.

The tables may store other data, and not all of the data in the tables described above may be necessary for some applications. Additional tables may be provided for example to record payment details of consumers in different formats.

All the scripts are driven from the database 110 by the scripting server 104 so that consumer interfaces can be generated by different clients automatically, without intervention.

The ancillary consumer-viewable output such as login screens, error messages and the like are stored in the form of text files held on the static template file store. The code for running on the scripting server 104 and consumer's computer 160 are also stored on the static template file store 106.

The consumer is made aware of a consumer interface relating to a specific product or service by an e-mail sent by the e-mail server 112 of the interface provider 100 to the email server 164 of the consumer's computer 160. All parameters that are passed from the interface provider 100 to the consumer's computer 160 and back are passed in the URL of the page to be requested.

As shown in FIG. 8, the e-mail server 114 sends an e-mail including a reference to the consumer interface, which is also stored in the database 110 of the interface provider, at S200. The consumer selects the launch URL from the e-mail at S202, which causes the consumer's computer 160 to launch web browser 162. The web browser 162 sends a request to the launch URL at the interface provider 100 at S204.

The launch URL is a web address directed to the interface provider, including a parameter. This parameter represents the consumer interface ID from the database 110, which is used as an index for all other parameters of the consumer interface. One parameter is a minimum. Two parameters may be provided in the URL namely a consumer interface ID and a consumer ID.

The interface provider 100 receives the launch URL request at S206 and reads the consumer interface ID from the request at S208. The interface provider 100 sends HTML code representing a request for a new browser window to the consumer, and also re-directs the existing browser window to the home web page of the client or any other web page specified by the client when they configure the consumer interface.

A new web browser is opened to ensure that the browser window is the correct size for the consumer interface. The existing browser window also gives more exposure of the client product or service to the consumer. The new browser is instructed to request a further URL on the interface provider. This further URL comprises the video ID and Graphical User Interface (GUI) ID from the database 110, together with instructions as to the web page that should be requested by the web browser.

The video ID and GUI ID together define all the parameters necessary for the consumer to request the consumer interface from the interface provider 100. However, the interface ID is also passed through so the URL so that it can be carried from script to script and request to request, so that it is always available to the interface provider for reference.

The consumer web browser 144 executes the requests for a new web browser and redirection at S212 and sends a request for a web page to the interface provider 100 at S214. The web page request includes the video ID and the GUI ID in the URL of the web page request.

The interface provider 100 identifies the video associated with the video ID at S216 and, in response, sends an HTML page including Java script and/or VB Script code in order to detect the media player plug-ins and line connection speed of the consumer's computer 160 at S218. Other scripting languages may also be used, where appropriate.

The consumer's computer 160 executes the Java script, and the line speed and the media players detected are recorded. A cookie is set on the consumer's computer 160 recording the media players available and the line speed at S220. If no valid media player is detected, or if the media player to be used can be selected by the consumer, a choice is offered to the consumer and/or an opportunity to download a media player is given.

When the media player and line connection speed have been detected, the consumer web browser 162 returns a refresh request for the same web page as at S214 to the interface provider 100. However, this time, the URL request additionally contains a flag, which has been set to indicate to the interface provider 100 that no detection of the media player and line speed is required at S222.

The interface provider 100 receives the second request containing the video ID and GUI ID at S224 and generates a dynamic HTML page representing the static information part of the consumer interface together with an embedded media player object at S226.

The static information part of the consumer interface is generated on request from the parameters of the consumer interface requested, held on the database 110. The parameters are passed to the interface provider 100 though the URL request provided by the consumer's web browser 162. The generation of the consumer interface is done by the scripting server 104, and data defining the consumer interface is read from the database 110. The scripting server 104 then retrieves the components of the static information part identified by the database data from the static template file store 106 and script store 108, and dynamically generates a consumer interface to be sent to the consumer.

The consumer web browser 164 displays the static information part of the consumer interface and initialises the media player embedded at S228. The consumer web browser 162 requests the video stream and supplies the interface provider 100 with the information contained in the cookie at S230.

The interface provider 100 uses the information regarding the media player and line speed to generate a metafile associated with the video clip of the consumer interface matching the consumer's computer 160 specification at S232. The metafile is received by the media player object and instructs the media player to contact video provider 120 with a URL containing a unique reference to the video to be played at S234.

The metafile indicates to the web browser (using HTTP content-type attributes) that the contents of the metafile are not to be displayed on the browser screen, but rather that the metafile represents a pointer to another file, which should be retrieved and displayed by the media player. The metafile is a text file containing a unique Hyperlink to the video provider streaming server 126 giving the address of the video to be downloaded to the consumer's computer 160. The browser receives the metafile and passes it to the video player, which then opens the connection to the video provider streaming server 126 and retrieves and outputs the streaming video.

The metafile is generated dynamically when the web browser 162 requests the video data. As a result of this dynamic creation, each link can be made valid for only one retrieval by, for example, including a time stamp on the metafile. The time stamp may be encrypted to prevent a consumer from deceiving the video provider streaming server 126, with an incorrect time reference, into providing the video clip. A time window is provided. This allows an interface to be requested again for a short period without recharging the consumer. The interface may be requested more than once if an error occurs in the streaming. Also, some web browsers automatically request a page twice without a user being aware of the fact, and this could otherwise result in double charging of a consumer where a new metafile would otherwise have been generated from the further request.

Such one-off metafiles allow each individual access to a particular video stream to be counted, even if the same consumer used the same video multiple times.

The video ends at S236. If it has been requested again, by the consumer selecting the ‘play’ button at S238, the process from step S222 is repeated. If the video is not requested again, the browser awaits input from the consumer at S240.

FIG. 9 shows additional steps in the method of FIG. 8. After step S224, the interface provider checks a field on the database giving the number of plays of the video clip authorised, together with the number of plays to date at S242. If the number of plays to date is equal to, or higher than, the authorised number of plays, the interface provider 100 returns a message to the consumer web browser at S244 stating that more credit is required. If the number of plays to date is lower than the authorised total number of plays, the interface provider proceeds.

The database 110 may also have a field relating to the purchase status of the video clip. The video clip may be free to download, or may be a pay-per-view video clip. The database 110 is accessed to determine whether the video requested is pay-per-view at S246. If the video is pay-per-view, the consumer must log in. The interface provider 100 determines whether or not the consumer is logged in at step S248.

The login status of a consumer for a pay-per-view video clip is stored in a variable in the interface provider 100 database 110, together with an ID, randomly-generated by the interface provider 100, which references that variable being stored on the consumer's computer 160. This is the session ID. Because a user would be unlikely to be able to guess correctly a session ID, they can only use the one that is generated for them and their log-in status is maintained securely and individually.

The session ID is stored in a session cookie, which is deleted at the end of a consumer session. The session ID is also used to store the video ID. This allows the consumer's computer to return the video ID if the video is requested again by pressing the ‘play’ button on the consumer interface. The session ID could also be used to store any other variables. However, these details are still passed in the URL requests and responses between the interface provider 100 and consumer's computer 160, because some consumers' computers 160 may not allow any kind of cookie use.

If the consumer is not logged in, a login screen is provided and the consumer logs on in order to retrieve the video at S250. The process then continues from step S226. If the user is already logged in, then the process goes directly to step S226.

FIG. 10 shows a further sequence in the process of FIG. 8. After step S230, the interface provider 100 checks again whether or not the video is marked as pay-per-view at S252. If the video is not pay-per-view, the interface provider 100 checks that the consumer has logged in at S254. Because the user has already had an opportunity to login in the process at S248, if the user is not logged in at this stage the request is fraudulent and is ignored and the process halts. If the request is not fraudulent, the interface provider then increments the number of plays of the video to date in the client table of the database at S256. If the video is not pay-per-view, the process goes from S252 to S264.

If the clip is pay-per-view, once the user has been checked as being logged in at S256, a further check is made to the database for the credit status of the consumer at S258. If the user has credit, the process proceeds to S264. If the user does not have credit, a check is made to see whether the consumer can be reverse billed at S260. If the consumer can be reverse billed then the consumer is charged at S262. If the user cannot be reverse billed the process ends.

The payment for a pay-per-view consumer interface may be made in any suitable way. The payment may be for a batch of credits, or on a single credit basis. The payment method may be a premium rate telephone number or a premium rate SMS text message, or various credit cards may be used for larger amounts. Paypal™ may also be used. A system where a premium rate telephone number is dialled and a unique pass code is supplied to the consumer may also be used. With mobile telephone communications, it is possible to use “reverse billing”. This works by the consumer subscribing by sending a keyword to a specified telephone number using their mobile phone. A password is sent back by text message and the user is charged for both outgoing and incoming text messages on the mobile phone.

Reverse billing, as at S260, can be carried out in the same way by sending a text message to the consumer, for which the consumer makes a payment.

The statistical information for the download is recorded on the database at S264. This statistical information can include the media player used and speed of connection, and any other information relating to the embodiment described above, or any other information, either individually, or in combination with any other piece of information. The number of times the clip has been accessed is updated at S266. If the initial request contained the consumer ID, then this is recorded with a timestamp and details of all actions carried out on the consumer interface. The process then continues as described from S232.

Other steps can be carried out to ensure that the access to the consumer interface is legitimate. For example, the number of times the clip has been accessed can be compared with number of hits the client has paid for. If the number of times the interface has been accessed is greater than the number of accesses paid for, either the consumer is misusing the provider or the interface has been called in error and an error message is returned to the consumer.

For debugging purposes, a log may be kept of all metafile video links that are generated, as this can help track down any problems in providing consumer interfaces to consumers. The log file recordal may be turned on or off.

As an optional addition, the consumer may also be able to contact the interface provider direct to personalize and set preferences regarding e-mails the consumers receive for consumer interfaces regarding different products and services of interest to them, in order to receive automatic e-mails whenever a consumer interface is created for a product of interest. This can be done by connecting through the Internet 20, by telephone, or e-mail for example.

It is also possible for consumers to register themselves for receiving consumer interfaces and to remove their e-mail address if they no longer wish to receive them. This can also be done by e-mail, telephone or through the Internet, for example.

Embodiments of the present invention can be implemented on specialised hardware, or in a combination of specialised hardware and software, or purely in software for instructing otherwise unmodified standard hardware.

The interface provider 100, client's computer 140 and consumer's computer 160 may each be a single computer, or themselves be networks of interconnected computers.

The interface provider 100, client's computer 140 and consumer's computer 160 can communicate using any means of communication, including computer communications, telecommunications and physical communications, for example by use of wireless technology, or facsimile or dedicated telephone line. For computer communications, any type or method of networking can be used including Extranet, Local Area Networks or wireless technology including Wireless Application Protocol (WAP).

Any software for providing embodiments of the invention can be provided on any suitable carrier medium such as a storage medium, e.g. a floppy disk, hard disk, CDROM, tape device, or solid-state memory device or a transient medium such as any type of signal, for example, an electric signal, optical signal, microwave signal, acoustic signal or magnetic signal (e.g. a signal carried over a communications network).

Any discussion of the prior art throughout the specification is not an admission that such prior art is widely known or forms part of the common general knowledge in the field.

Unless the context clearly requires otherwise, throughout the description and the claims, the word “comprised” and the like are used in an inclusive as oppose to an exclusive or exhaustive sense, that is to say, in the sense of “include, but not limited to”.

The present invention has been described above purely by way of example, and modifications can be made within the spirit of the invention. The invention also consists of any individual features described or implicit herein or as shown or implicit in the drawings or in any combination of such features or any generalisation of any such features or combination. Each feature disclosed in the specification, including the claims, abstract and drawings, may be replaced by alternative features serving the same, equivalent or similar purposes, unless expressly stated otherwise.

What is claimed is:

1. Apparatus for allowing a marketing entity to deliver marketing information to a target group of consumers, the apparatus comprising:
consumer interface configuration means for allowing the marketing entity to generate or modify data defining at least a part of a consumer interface for information related to a service or product;
consumer interface storing means for storing data defining at least a part of at least one consumer interface;
consumer data storing means for storing consumer data, including contact details;
associating means for associating a target group of consumers identified by corresponding consumer data in the consumer data storing means with a consumer interface related to a product or service;
notifying means for facilitating the notification of the target group of consumers of the consumer interface; and
consumer interface provision means for accessing the consumer interface storing means to provide the consumer interface to the consumers to allow the consumers to access the information related to a product or service.

2. Apparatus according to claim 1, wherein said consumer interface configuration means includes:
receiving means for receiving a request to generate or modify at least a part of a consumer interface;
means for identifying information related to a service or product to be accessed via the consumer interface;
display output means for outputting consumer interface configuration parameters for defining the configuration of the consumer interface;
parameter selection receiving means for receiving at least one consumer interface configuration parameter selection; and
associating means for associating the identified information and the or each consumer interface configuration parameter selection with the consumer interface to provide the data defining the consumer interface for information related to the service or product.

3. Apparatus according to claim 1, wherein said notifying means is adapted to send notifications in electronic form to the consumers using the contact details stored in the consumer data storing means.

4. Apparatus according to claim 1, wherein the consumer interface configuration means is adapted to allowing the marketing entity to generate or modify data defining at least a part of a consumer interface for dynamic information related to a service or product.

5. Apparatus according to claim 4, wherein the consumer interface configuration means is adapted to allowing the marketing entity to generate or modify data defining at least a part of a consumer interface for a video or audio clip and other information related to a service or product.

6. Apparatus according to claim 1, wherein the consumer interface provision means comprises:
receiving means for receiving a request for a consumer interface from a consumer;
consumer interface generation means for generating at least part of a consumer interface from data stored in the consumer interface storing means; and
provision means for outputting the at least part of the consumer interface to the consumer.

7. Apparatus according to claim 6, wherein the provision means further provides a unique logical address associated with the consumer interface, the unique logical address to be used by the consumer to retrieve another part of the consumer interface.

8. Apparatus according to claim 1, wherein at least part of the consumer interface is defined in mark-up language accessible over a network.

9. Apparatus according to claim 8, wherein the provision means comprises markup server means.

10. Apparatus according to claim 1, wherein the notifying means is adapted to generate a list of consumers for use in notification.

11. Apparatus according to claim 1, wherein the notifying means is adapted to automatically send notification over a communication network.

12. A method of allowing a marketing entity to deliver marketing information to a target group of consumers, the method comprising:
generating or modifying data defining at least part of a consumer interface for information related to a service or product;
storing data defining at least part of at least one consumer interface in a consumer interface store;
storing consumer data, including contact details in a consumer data store;
associating a target group of consumers identified by corresponding consumer data in the consumer data store with a consumer interface related to a product or service;
facilitating the notification of the target group of consumers of the consumer interface; and
accessing the consumer interface store to provide the consumer interface to the consumers to allow the consumers to access the information related to a product or service.

13. A method according to claim 12, wherein the data defining at least part of a consumer interface for information related to a service or product is generated or modified by:
receiving a request to generate or modify a consumer interface; identifying information related to a service or product to be accessed via the consumer interface;
outputting for display consumer interface configuration parameters for defining at least part of the configuration of the consumer interface;
receiving at least one consumer interface configuration parameter selection; and
associating the identified information and the or each consumer interface configuration parameter selection with the consumer interface to provide the data defining the consumer interface for information related to the service or product.

14. A method according to claim 12, wherein notifications are sent in electronic form to the consumers using the contact details stored in the consumer data store.

15. A method according to claim 12, wherein the consumer interface comprises a consumer interface for dynamic information related to a service or product.

16. A method according to claim 15, wherein the consumer interface comprises a consumer interface for a video or audio clip and other information related to a service or product.

17. A method according to claim 12, further comprising:
receiving a request for a consumer interface from a consumer;
generating at least a part of a consumer interface from data stored in the consumer interface store;
outputting the at least part of the consumer interface to the consumer.

18. A method according to claim 17, further comprising:
outputting a logical address associated with the at least part of the consumer interface, to be used by the consumer to retrieve another part of the consumer interface.

19. A method according to claim 12, including defining the consumer interface in mark-up language accessible over a network.

20. A method according to claim 12, including generating a list of consumers for use in notification.

21. A method according to claim 12, including notifying the target group of users automatically.

22. A computer apparatus for allowing a marketing entity to deliver marketing information to a target group of consumers, the apparatus comprising:
a program memory storing instructions for controlling a processor; and
a processor for reading and implementing the instructions stored in the program memory;
wherein the program instructions stored in the program memory comprise instructions for controlling the processor to:
generate or modify data defining at least part of a consumer interface for information related to a service or product;
store data defining at least part of at least one consumer interface in a consumer interface store;
store consumer data, including contact details in a consumer data store;
associate a target group of consumers identified by corresponding consumer data in the consumer data store with a consumer interface related to a product or service;
facilitate the notification of the target group of consumers of the consumer interface; and
access the consumer interface storing means to provide the consumer interface to the consumers to allow the consumers to access the information related to a product or service.

23. A computer apparatus according to claim 22, wherein the program instructions stored in the program memory comprise instructions for controlling the processor to generate or modify the data defining at least part of a consumer interface for information related to a service or product by:
receiving a request to generate or modify a consumer interface;
identifying information related to a service or product to be accessed via the consumer interface;
outputting for display consumer interface configuration parameters for defining at least part of the configuration of the consumer interface;
receiving at least one consumer interface configuration parameter selection; and
associating the identified information and the or each consumer interface configuration parameter selection with the consumer interface to provide the data defining the consumer interface for information related to the service or product.

24. A computer apparatus according to claim 22, wherein the program instructions stored in the program memory comprise instructions for controlling the processor to send notifications in electronic form to the consumers using the contact details stored in the consumer data store.

25. A computer apparatus according to claim 22, wherein the consumer interface comprises a consumer interface for dynamic information related to a service or product.

26. A computer apparatus according to claim 25, wherein the consumer interface comprises a consumer interface for a video or audio clip and other information related to a service or product.

27. A computer apparatus according to claim 22, wherein the program instructions stored in the program memory comprise instructions for controlling the processor to:
receive a request for a consumer interface from a consumer;
generate at least a part of a consumer interface from data stored in the consumer interface store;
output the at least part of the consumer interface to the consumer.

28. A computer apparatus according to claim 27, wherein the program instructions stored in the program memory comprise instructions for controlling the processor to output a logical address associated with the at least part of the consumer interface, to be used by the consumer to retrieve another part of the consumer interface.

29. A computer apparatus according to claim 22, wherein the program instructions stored in the program memory comprise instructions for controlling the processor to define the consumer interface in mark-up language accessible over a network.

30. A computer apparatus according to claim 22, wherein the program instructions stored in the program memory comprise instructions for controlling the processor to generate a list of consumers for use in notification.

31. A computer apparatus according to claim 22, wherein the program instructions stored in the program memory comprise instructions for controlling the processor to notify the target group of users automatically.

32. A carrier medium carrying computer readable code for controlling a computer to allow a marketing entity to deliver marketing information to a target group of consumers by:
generating or modify data defining at least part of a consumer interface for information related to a service or product;
storing data defining at least part of at least one consumer interface in a consumer interface store;
storing consumer data, including contact details in a consumer data store;
associating a target group of consumers identified by corresponding consumer data in the consumer data store with a consumer interface related to a product or service;
facilitating the notification of the target group of consumers of the consumer interface; and
accessing the consumer interface storing means to provide the consumer interface to the consumers to allow the consumers to access the information related to a product or service.

33. A carrier medium according to claim 32, wherein the computer readable code is adapted to control the computer to generate or modify the data defining at least part of a consumer interface for information related to a service or product by:
receiving a request to generate or modify a consumer interface;
identifying information related to a service or product to be accessed via the consumer interface;
outputting for display consumer interface configuration parameters for defining at least part of the configuration of the consumer interface;
receiving at least one consumer interface configuration parameter selection; and
associating the identified information and the or each consumer interface configuration parameter selection with the consumer interface to provide the data defining the consumer interface for information related to the service or product.

34. A carrier medium according to claim 32, wherein the computer readable code is adapted to control the computer to send notifications in electronic form to the consumers using the contact details stored in the consumer data store.

35. A carrier medium according to claim 32, wherein the consumer interface comprises a consumer interface for dynamic information related to a service or product.

36. A carrier medium according to claim 35, wherein the consumer interface comprises a consumer interface for a video or audio clip and other information related to a service or product.

37. A carrier medium according to claim 32, wherein the computer readable code is adapted to control the computer to
receive a request for a consumer interface from a consumer;
generate at least a part of a consumer interface from data stored in the consumer interface store;
output the at least part of the consumer interface to the consumer.

38. A carrier medium according to claim 32, wherein the computer readable code is adapted to control the computer to:
output a logical address associated with the at least part of the consumer interface, to be used by the consumer to retrieve another part of the consumer interface.

39. A carrier medium according to claim 32, wherein the computer readable code is adapted to control the computer to define the consumer interface in mark-up language accessible over a network.

40. A carrier medium according to claim 32, wherein the computer readable code is adapted to control the computer to generate a list of consumers for use in notification.

41. A carrier medium according to claim 32, wherein the computer readable code is adapted to control the computer to notify the target group of users automatically.

42. Apparatus for generating or modifying data defining at least part of a consumer interface for dynamic information related to a topic, the apparatus comprising:
request receiving means for receiving a request to generate or modify at least part of a consumer interface;
information receiving means for receiving the identity of information to be accessed via the consumer interface, wherein the identified information includes dynamic information to be streamed to a consumer within the consumer interface and associated static information;
display output means for outputting consumer interface configuration parameters including template information for defining the configuration of the consumer interface;
parameter selection receiving means for receiving at least one consumer interface parameter selection; and
associating means for associating the identified information and the or each consumer interface configuration parameter selection with the consumer interface to provide the data defining the consumer interface for information related to the topic.

43. Apparatus according to claim 42, wherein the information is multimedia information.

44. Apparatus according to claim 42, including means for receiving a consumer request for a consumer interface and responding to the consumer request by sending the configured consumer interface.

45. Apparatus according to claim 42, including means for generating at least part of the consumer interface dynamically in response to a request from a consumer to receive the consumer interface.

46. Apparatus according to claim 45, including means for generating the associated static information dynamically in response to the request from a consumer.

47. A method of generating or modifying data defining at least part of a consumer interface for information related to a topic, the method comprising:
receiving a request to generate or modify a consumer interface;
receiving the identity of information to be accessed via the consumer interface, wherein the identified information includes dynamic information to be streamed to a consumer within the consumer interface and associated static information;
outputting for display consumer interface configuration parameters including template information for defining the configuration of the consumer interface;
receiving at least one consumer interface parameter selection; and
associating the identified information and the or each consumer interface configuration parameter selection with the consumer interface to provide the data defining the consumer interface for information related to the topic.

48. A method according to claim 47, wherein the identified information is multimedia information.

49. A method according to claim 47, including receiving a consumer request for a consumer interface and responding to the consumer request by sending the configured consumer interface.

50. A method according to claim 47, including generation of at least part of the consumer interface dynamically in response to a request from a consumer to receive the consumer interface.

51. A method according to claim 50, including generating the associated static information dynamically in response to the request from a consumer.

52. A computer apparatus for generating or modifying data defining a consumer interface for dynamic information related to a topic, the apparatus comprising:
a program memory storing instructions for controlling a processor; and
a processor for reading and implementing the instructions stored in the program memory;
wherein the program instructions stored in the program memory comprise instructions for controlling the processor to:
receive a request to generate or modify a consumer interface;
receive the identity of information to be accessed via the consumer interface, wherein the identified information includes dynamic information to be streamed to a consumer within the consumer interface and associated static information;
output for display consumer interface configuration parameters including template information for defining the configuration of the consumer interface;
receive at least one consumer interface parameter selection; and
associate the identified information and the or each consumer interface configuration parameter selection with the consumer interface to provide the data defining the consumer interface for information related to the topic.

53. A computer apparatus according to claim 52, wherein the identified information is multimedia information.

54. A computer apparatus according to claim 52, wherein the program instructions stored in the program memory comprise instructions for controlling the processor to receive a consumer request for a consumer interface and responding to the consumer request by sending the configured consumer interface.

55. A computer apparatus according to claim 52, wherein the program instructions stored in the program memory comprise instructions for controlling the processor to generate at least part of the consumer interface dynamically in response to a request from a consumer to receive the consumer interface.

56. A computer apparatus according to claim 55, wherein the program instructions stored in the program memory comprise instructions for controlling the processor to generate the associated static information dynamically in response to the request from a consumer.

57. A carrier medium carrying computer readable code for controlling a computer to generate or modify data defining a consumer interface for dynamic information related to a topic by:
receiving a request to generate or modify a consumer interface;
receiving the identity of information to be accessed via the consumer interface, wherein the identified information includes dynamic information to be streamed to a consumer within the consumer interface and associated static information;
outputting for display consumer interface configuration parameters including template information for defining the configuration of the consumer interface;
receiving at least one consumer interface parameter selection; and
associating the identified information and the or each consumer interface configuration parameter selection with the consumer interface to provide the data defining the consumer interface for information related to the topic.

58. A carrier medium according to claim 57, wherein the identified information is multimedia information.

59. A carrier medium according to claim 57, wherein the computer readable code is adapted to control the computer to receive a consumer request for a consumer interface and responding to the consumer request by sending the configured consumer interface.

60. A carrier medium according to claim 57, wherein the computer readable code is adapted to control the computer to generate at least part of the consumer interface dynamically in response to a request from a consumer to receive the consumer interface.

61. A carrier medium according to claim 60, wherein the computer readable code is adapted to control the computer to generate the associated static information dynamically in response to the request from a consumer.

62. Apparatus for allowing a marketing entity to make information on a product or service available to consumers and to monitor the accessing of the information, the apparatus comprising:
information providing means for providing information on a product or service accessible over an electronic network;
contacting means for contacting consumers over the electronic network to inform them of the availability of the information; and
monitoring means for monitoring the accessing of the information by consumers.

63. Apparatus according to claim 62, further comprising:
consumer profile data store means for storing consumer profile data; and
consumer contact means for contacting consumers based on the profile of consumers.

64. Apparatus according to claim 62, further comprising:
consumer access recording means for recording the accessing of consumer interfaces by consumers; and
consumer profile data modification means for modifying the consumer profile based on access of the consumer interfaces by consumers.

65. Apparatus according to claim 62, wherein the information providing means is for providing dynamic information including video or audio stream information.

66. A method of allowing a marketing entity to make information on a product or service available to consumers and to monitor the accessing of the information, the method comprising:
providing information on a product or service accessible over an electronic network;
contacting consumers over the electronic network to inform them of the availability of the information; and
monitoring the accessing of the information by consumers.

67. A method according to claim 66, further comprising:
storing consumer profile data; and
contacting consumers based on the profile of consumers.

68. A method according to claim 66, further comprising:
recording the accessing of consumer interfaces by consumers; and
modifying the consumer profile based on access of the consumer interfaces by consumers.

69. A method according to claim 66, wherein the information is provided as dynamic information including video or audio stream information.

70. A computer apparatus for allowing a marketing entity to deliver marketing information to a target group of consumers, the apparatus comprising:
a program memory storing instructions for controlling a processor; and
a processor for reading and implementing the instructions stored in the program memory;
wherein the program instructions stored in the program memory comprise instructions for controlling the processor to:
provide information on a product or service accessible over an electronic network;
contact consumers over the electronic network to inform them of the availability of the information; and
monitor the accessing of the information by consumers.

71. A computer apparatus according to claim 70, wherein the program instructions stored in the program memory comprise instructions for controlling the processor to:
store consumer profile data; and
contact consumers based on the profile of consumers.

72. A computer apparatus according to claim 70, wherein the program instructions stored in the program memory comprise instructions for controlling the processor to:
record the accessing of consumer interfaces by consumers; and
modify the consumer profile based on access of the consumer interfaces by consumers.

73. A computer apparatus according to claim 70, wherein the program instructions stored in the program memory comprise instructions for controlling the processor to provide the information as dynamic information including video or audio stream information.

74. A carrier medium carrying computer readable code for controlling a computer to allow a marketing entity to make information on a product or service available to consumers and to monitor the accessing of the information by:
providing information on a product or service accessible over an electronic network;
contacting consumers over the electronic network to inform them of the availability of the information; and
monitoring the accessing of the information by consumers.

75. A carrier medium according to claim 74, wherein the computer readable code is adapted to control the computer to:
store consumer profile data; and
contact consumers based on the profile of consumers.

76. A carrier medium according to claim 74, wherein the computer readable code is adapted to control the computer to:
record the accessing of consumer interfaces by consumers; and
modify the consumer profile based on access of the consumer interfaces by consumers.

77. A carrier medium according to claim 74, wherein the computer readable code is adapted to control the computer to provide the information as dynamic information including video or audio stream information.

78. Apparatus for allowing a marketing entity to deliver marketing information to a target group of consumers, the apparatus comprising:
consumer interface storing means for storing data defining at least part of at least one consumer interface;
consumer data storing means for storing consumer data, including contact details;
associating means for associating a target group of consumers identified by corresponding consumer data in the consumer data storing means with a consumer interface related to a product or service;
notifying means for facilitating the notification of the target group of consumers of the consumer interface; and
consumer interface provision means for accessing the consumer interface storing means to provide the consumer interface to the consumers to allow the consumers to access the information related to a product or service, the consumer interface provision means comprising receiving means for receiving a request for a consumer interface from a consumer and consumer interface generation means for generating at least part of a consumer interface from data stored in the consumer interface storing means.

79. Apparatus according to claim 78, wherein the provision means further provides a unique logical address associated with the consumer interface, the unique logical address to be used by the consumer to retrieve another part of the consumer interface.

80. A method for allowing a marketing entity to deliver marketing information to a target group of consumers, the method comprising:
storing data defining at least part of at least one consumer interface in a consumer interface store;
storing consumer data, including contact details in a consumer data store;
associating a target group of consumers identified by corresponding consumer data in the consumer data store with a consumer interface related to a product or service;
facilitating the notification of the target group of consumers of the consumer interface;
receiving a request for a consumer interface from a consumer;
accessing the consumer interface storing means to provide the consumer interface to the consumers to allow the consumers to access the information related to a product or service; and
generating at least a part of a consumer interface from data stored in the consumer interface storing means.

81. A method according to claim 80, further comprising:
outputting a logical address associated with the consumer interface, to be used by the consumer to retrieve another part of the consumer interface.

82. A method of displaying a consumer interface for dynamic information related to a specific product or service, the method comprising:
requesting information related to the product or service from a remote provider;
receiving a consumer interface comprising static information and instructions to request dynamic information, to be streamed to the consumer within the consumer interface, associated with the static information, to be accessed via the consumer interface;
carrying out the instructions to request the dynamic information; and
receiving and displaying the dynamic information in conjunction with the static information.

83. A method according to claim 82, further comprising monitoring the accessing of the information by consumers.

84. A computer apparatus displaying a consumer interface for dynamic information related to a specific product or service, the apparatus comprising:
a program memory storing instructions for controlling a processor; and
a processor for reading and implementing the instructions stored in the program memory;
wherein the program instructions stored in the program memory comprise instructions for controlling the processor to:
request information related to the product or service from a remote provider;
receive a consumer interface comprising static information and instructions to request dynamic information, to be streamed to the consumer within the consumer interface, associated with the static information, to be accessed via the consumer interface;
carry out the instructions to request the dynamic information; and
receive and displaying the dynamic information in conjunction with the static information.

85. A computer apparatus according to claim 84, wherein the program instructions stored in the program memory comprise instructions for controlling the processor to monitor the accessing of the information by consumers.

86. A carrier medium carrying computer readable code for controlling a computer to display a consumer interface for dynamic information related to a specific product or service by:
requesting information related to the product or service from a remote provider;
receiving a consumer interface comprising static information and instructions to request dynamic information, to be streamed to the consumer within the consumer interface, associated with the static information, to be accessed via the consumer interface;
carrying out the instructions to request the dynamic information; and
receiving and displaying the dynamic information in conjunction with the static information.

87. A carrier medium according to claim 86, wherein the computer readable code is adapted to control the computer to monitor the accessing of the information by consumers.

88. A method of providing display information for a consumer interface containing dynamic information related to a specific product or service, the method comprising:
receiving a request for information related to the product or service from a remote consumer;
sending a consumer interface comprising static information and instructions to request dynamic information, to be streamed to the consumer within the consumer interface, associated with the static information, to be accessed via the consumer interface;
generating the static information, based on information held in an information store; and
outputting for display the generated static information.

89. A method according to claim 88, further comprising monitoring and recording the requests for information received, and static information generated.

90. A computer apparatus displaying a consumer interface for dynamic information related to a specific product or service, the apparatus comprising:
a program memory storing instructions for controlling a processor; and
a processor for reading and implementing the instructions stored in the program memory;
wherein the program instructions stored in the program memory comprise instructions for controlling the processor to:
receive a request for information related to the product or service from a remote consumer;
send a consumer interface comprising static information and instructions to request dynamic information, to be streamed to the consumer within the consumer interface, associated with the static information, to be accessed via the consumer interface;
generate the static information, based on information held in an information store; and
outputt for display the generated static information.

91. A computer apparatus according to claim 84, wherein the program instructions stored in the program memory comprise instructions for controlling the processor to monitor and record the requests for information received, and static information generated.

92. A carrier medium carrying computer readable code for controlling a computer to provide display information for a consumer interface containing dynamic information related to a specific product or service by:
receiving a request for information related to the product or service from a remote consumer;
sending a consumer interface comprising static information and instructions to request dynamic information, to be streamed to the consumer within the consumer interface, associated with the static information, to be accessed via the consumer interface;
generating the static information, based on information held in an information store; and
outputting for display the generated static information.

93. A carrier medium according to claim 92, wherein the computer readable code is adapted to control the computer to monitor and record the requests for information received, and static information generated.
